(19) United States
(12) Patent Application Publication
(10) Pub. No.: US 2008/0275867 A1
(43) Pub. Date: Nov. 6, 2008

(54) System and Method for Presenting Content to a User

(75) Inventors: Gerrit Hollemans, Eindhoven (NL); Vincent P. Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,794

(22) PCT Filed: Nov. 28, 2006
(86) PCT No.: PCT/IB2006/054492

§ 371 Date: Jun. 2, 2008

Related U.S. Application Data
(60) Provisional application No. 60/741,297, filed on Dec. 1, 2005.

(51) Int. Cl. G06F 17/30

(52) U.S. Cl. 707/5; 707/E17.014

(57) ABSTRACT

Assisting a user in locating particular content of interest from a collection of content including associated feature values and corresponding features. A user selects one of the plurality of feature values characterizing the collection of content and filters the content using the selected filtering feature value. The system groups the filtered collection using a grouping feature. The grouping feature may be associated with the user-selected filtering feature value and/or may be determined from the feature values of the filtered collection. The process of filtering/grouping may be repeated as many times as needed to locate the particular content of interest.

The present system generally relates to information retrieval, and in particular, to a system and method that assists a user in locating particular content of interest from a collection of content.

Today we are seeing a proliferation in available content that lends itself to being easily collected by the average consumer. Some typical examples of available content include music libraries of CDs, video libraries of DVDs and large numbers of photographs stored on computers with the advent of affordable digital cameras and large storage capacities. The content may be collected directly by the consumer and/or also may be obtained from any number of available sources including obtaining it over a network such as the Internet (e.g., photo libraries, peer-to-peer music downloading sites). However, mere access to large amounts of content has only limited value if the ability of consumers to readily, timely and effectively identify, select, access, and retrieve the content remains more limited and difficult than necessary. Searching for particular content of interest in a huge amount of structured and/or unstructured content may be a very daunting and time-consuming task.

To aid in finding content, a user may simply search for terms that are within a portion of the content. For example, when a user searches for a given text content, the user may search (filter) for text that is contained within the content. For other types of content, a user may search for a name of the content that is stored in a look-up table of content, such as a file allocation table (FAT). To assist in searching for complex content, wherein perhaps a given file name association is not known, systems exist that enable an association of feature descriptors for given content. For example, meta-data is definitional data that provides information about and/or documentation of associated content that may include data about data elements or attributes of the associated content, such as name, size, data type, etc. Meta-data may also include descriptive information about the context, quality and condition, or characteristics of the associated content. Metadata may be already associated with content, such as content provided from a remote storage device. Metadata may also be associated with content by devices that create the content, such as a digital camera that creates metadata for pictures taken on the camera, such as camera setting, time of photograph, etc. Further, metadata may be inserted by a user of the content and/or may be created by an automated process that scrutinizes the content for features.

Search systems are available that facilitate a filter of available content (content may be available locally and/or may be available over a network) to arrive at a meaningful subset to view. These search systems search features of the content (metadata, names, size, etc.) for identifiers that are the same or similar as search terms. According to one approach for filtering a collection of content to arrive at a meaningful subset to view, a user selects a particular feature value to filter the collection of content. The user may continue to further filter the collection of content according to a second user-selected feature value to try and arrive at a meaningful sub-collection of content. For example, in the case of a set of photographs belonging to a user, the user may choose to filter the set of photographs based on a particular user-selected event, such as a birthday or a vacation. The user may then further filter the filtered set of photographs using another user-selected value of another feature, such as PERSONS. At the end of this process, if the resulting list of filtered photographs is determined to be unmanageable, the process may be repeated as many times as is necessary to reduce the set of photographs to a manageable subset that is determined to be meaningful to the user.

It is noted, however, that the above cited approach is not without drawbacks. One drawback is that a user may not know all of the values to use in filtering the initial collection of content when searching for specific content. For example, when searching for a photograph, the user may know the event of the photograph, such as a birthday, and a name of the person in the photograph, but not the date or location of the photograph. A second drawback is that when a system performs the operations associated with the filtering approach described above, the end result may yield only a very small subset of content or possibly no content when a match of all filter features is not found within the content. This is undesirable in the sense that it limits the amount of content that the user gets to view and may not provide the user with a particular desired content item or group of content items (e.g., a desired album of photographs).

A further drawback associated with the approach is that when a system performing the operations associated with the prior-art filtering approach selects values to filter on, the selected values for a subset of the features may not be certain. For example, in the case where content analysis is being performed, for example using image/face recognition, on a large collection of content, such as photographs, to create metadata for the photographs, the system may detect the presence of a given person on a given photograph, but this information is uncertain and may be incorrect. That is, for the feature PERSON, a given photograph's associated value is uncertain because the system may have incorrectly identified the person and thereby, associated a wrong metadata value with the photograph. Thereafter, when searching for this photograph, if the user specifies a correct person in the photograph during a search, the prior art system may never find the proper photograph because of the wrong associated value for that person.

Each of the above cited drawbacks also includes the associated risk that further filtering may focus in on a wrong subset of content. Specifically, with reference to the first drawback cited above, current solutions in the prior art require the user to repeatedly try values for each feature, one-by-one, and inspect each individual result, which may be cumbersome and time-consuming. Otherwise, the prior art requires the user to work with the entire initial list of content (photographs), which is difficult to manage and consequently, also cumbersome and time-consuming. With reference to each of the above prior art solutions, the user or system may incorrectly combine feature values to filter the content and thereby, zoom into the wrong subset of content.

It would therefore be desirable to provide a way to locate content of interest to a user from a set of content which overcomes the limitations of the prior art described above and/or others.

The present system provides a computer program product, and an associated method for performing sorting and filtering operations, in such a manner that allows a user to locate particular content from among a collection of content.

According to one aspect of the present system, a method for assisting a user in locating particular content of interest from a collection of content may include the following acts/operations. Determining by the user to filter the collection of content to yield a filtered subset of content using a filtering feature value, wherein the filtering feature value is user-selected. Thereafter, selecting a grouping feature based on the filtering feature value or the results of the filtering and grouping the filtered collection of content using the selected grouping feature and corresponding grouping feature values. The filtered/grouped collection of content may then be displayed to the user.

According to one aspect, the filtering operation is performed based on a user-selected filtering feature value and the grouping operation is performed automatically based on a grouping feature. The user-selected filtering feature value and grouping feature being selected from the same domain of feature values that are predetermined and/or are associated with the collection of content. For example, filtering may be performed using a particular LOCATION filtering feature value as the user-selected filtering feature value. In this case, it is assumed that each item and/or group of items (e.g., albums) in the large collection of content includes meta-data or other means of describing LOCATION feature values of the content. The meta-data describing the various feature values may be determined a-priori or otherwise determined dynamically, in real-time using techniques such as image recognition. For example, image recognition software may be utilized to analyze the collection of content in real time to dynamically ascertain certain content characteristics that are typically associated with location. Once determined, that feature value may be associated or appended to the content as meta-data.

According to another aspect, filtering and grouping operations may be performed prior to or subsequent to the operation of the present system. The process of locating particular content of interest to a user may be fluid and dependent in part on the observance of intermediate results. Any intermediate results may determine the need for further filtering and/or grouping operations on a collection of content.

In another aspect, a system for assisting a user in locating particular content of interest to the user from a collection of content includes a content locator module configured to manage operations associated with filtering and/or grouping the collection of content, and a feature structure model, operatively coupled to the content locator module, comprised of a plurality of rows, each of the rows including a filtering feature and at least one associated grouping feature having corresponding grouping feature values. The feature structure model also includes rules to determine varying grouping feature values to retain a sufficient quantity of content to provide sufficient context to the user.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present invention.

It should be expressly understood that the drawings are included for illustrative purposes and do not represent the scope of the present invention.

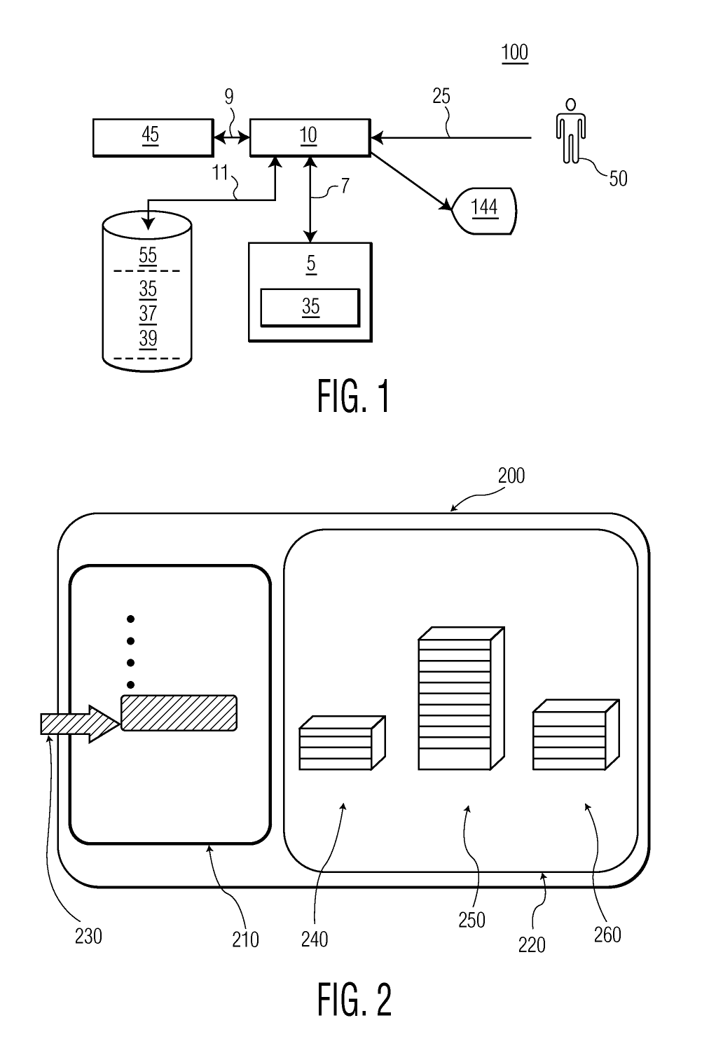

FIG. 1 illustrates a high-level architecture of a computer system in which a system and associated method for performing the present method may be used;

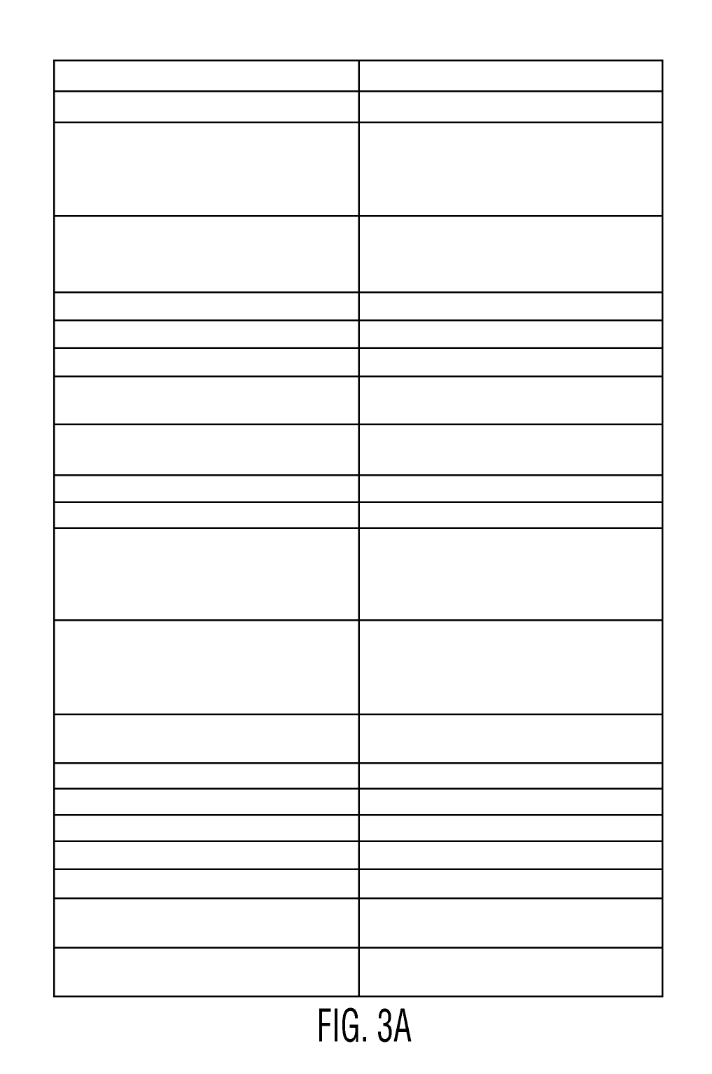

FIG. 2 illustrates a method of operation according to one embodiment;

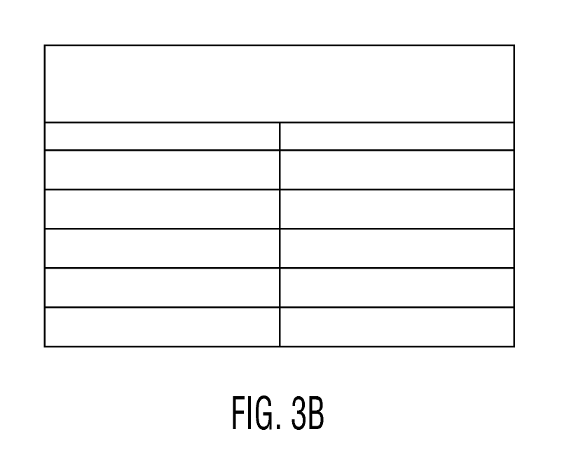

FIG. 3A shows exemplary features (classes) of content with corresponding feature values (instances);

FIG. 3B is an exemplary feature structure model for use in the present system to determine which features to choose to perform filtering/grouping operations, according to one embodiment; and

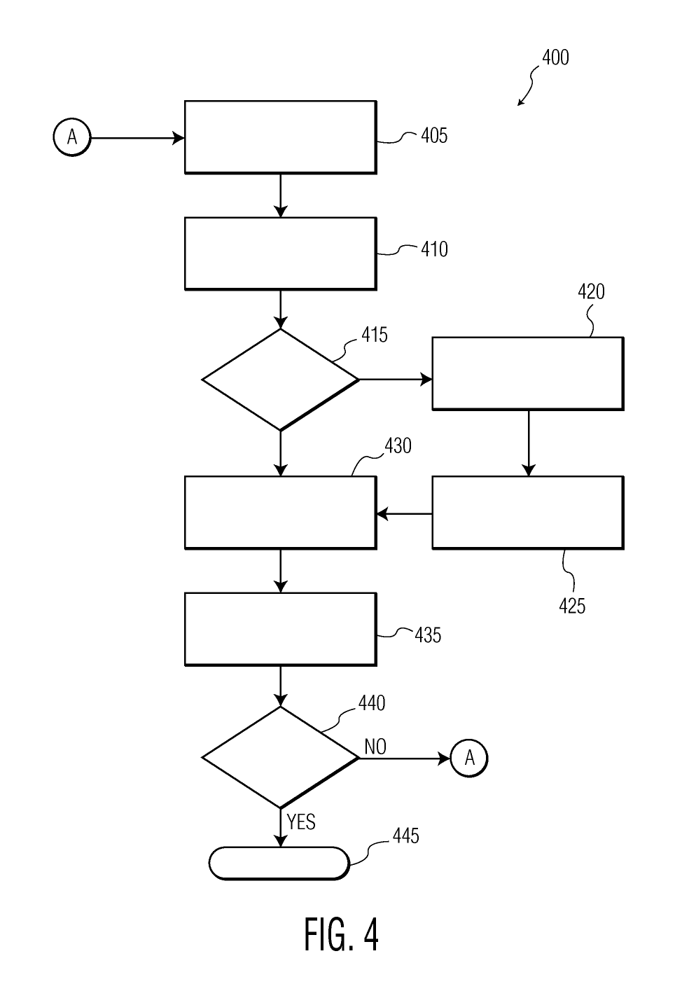

FIG. 4 is an exemplary flow diagram illustrating operation in accordance with an embodiment of the present system.

When the following terms are used herein, the accompanying definitions apply:

database—one or more structured sets of persistent data, usually associated with software to update and query the data. A simple database might be a single file containing many records, where the individual records use the same set of fields. A database may comprise a map wherein various identifiers are organized according to various factors, such as identity, physical location, location on a network, function, etc.;

executable application—code or machine readable instructions for implementing predetermined functions including those of an operating system, healthcare information system, or other information processing system, for example, in response to a user command or input;

executable procedure—a segment of code (machine readable instruction), sub-routine, or other distinct section of code or portion of an executable application for performing one or more particular processes and may include performing operations on received input parameters (or in response to received input parameters) and provide resulting output parameters;

grouping—a visual arrangement of content items such that content items that are visually placed in close proximity have the same feature value for the feature on which the grouping is performed;

information—data;

processor—a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor; and

user interface—a tool and/or device for rendering information to a user and/or requesting information from the user. A user interface includes at least one of textual, graphical, audio, video and animation elements.

While the system is described herein in the context of a collection of content comprising a photograph collection, such as a collection of a plurality of photo albums, such is discussed by way of example. Those skilled in the art will appreciate that the system is applicable to any collection of content for which a user desires to locate a particular content item of interest.

In addition to the features described above, the system provides a number of specific features and advantages over prior art systems including, without limitation: facilitating the user's ability to locate particular content of interest without having to specify or know each and every feature value associated with the content; using information on the relative importance of features to perform relevant grouping operations on filtered content; and using a relation between values of different features and an associated mechanism of grouping.

FIG. 1 portrays an exemplary high-level architecture of a computer system 100 in which a system and associated method for performing filtering and grouping operations, in such a manner that allows a user to locate particular content from among a collection of content, may be used. Computer System 100 may be embodied, for example, as a personal computer based on a processor. In addition to the processor, the personal computer includes a keyboard for entering data (not shown), a monitor (display 144) for displaying information, a storage device (database 55) for the storage of content, one or more executable applications (content locator module 10), one or more tables (feature structure model 45) and a memory unit 5 to store content during execution. Content locator module 10 is shown operationally coupled to the memory 5 via communication link 7, operationally coupled to the feature structure model 45 via communication link 9 and operationally coupled to the database 55 via communication link 11.

The content locator module 10 comprises an executable application that controls the grouping and filtering operations. Content locator module 10 is configured to perform the method acts of the present system and includes a software programming code or computer program product that is typically embedded within, or installed on a computer. Alternatively, content locator 10 may be software programming code saved on a suitable storage medium such as a diskette, a CD, a hard drive, or like devices that are operated on by a processor. In other embodiments, hardware circuitry may be used in place of, or in combination with, software instructions to implement the present system.

In one embodiment, filtering and grouping commands 25 are generated by a user 50 and are input to the content locator 10. Results of the filtering and grouping commands generated by the content locator module 10 are displayed to the user 50 on display 144.

In the present illustrative embodiment, FIG. 1 illustrates three collections stored in the database 55 of computer system 100. They include a collection of photographs 35, a collection of music tracks 37, and a stamp collection 39. The collection of photographs, music tracks and stamps may be generally defined herein as content. Each individual photograph, music track and stamp within its respective collection may be defined as an individual content item and/or may be defined as a member of a content group, such as a photo album. For example, a photograph may be defined individually and/or as a part of an album. As used herein, unless specified otherwise, the term content item is intended to encompass an individual content item generally, and/or a grouping of individual content items. Each of the content items within the collections has associated one or more feature values. For example, the content items within the photo collection may each include associated features, for example identifying an event depicted in content items, a location depicted in the content items, persons depicted within content items, an identification of objects depicted within content items, and date & time of content item creation. These features may have values, referred to herein as feature values. For example, the event feature may have a value such as holiday and/or an identification of a given holiday associated with the content generally, and/or a given content item specifically. The object feature may have a value of umbrella and so on. Each content item in a collection may have one or more feature values associated with it. The present system utilizes these features and their associated feature values, when known, to facilitate locating particular content items from among the collection and/or collections of content.

FIG. 3A shows exemplary features (classes) of content with corresponding feature values (instances). Using terminology defined in Unified Modeling Language (UML) as for instance described in “UML Distilled—Applying The Standard Object Modeling Language”, by M. Fowler, Addison-Wesley Longman, Inc., Massachusetts, USA, 1997, a class is a type description for a defined set of data elements herein described as features. Instances are data elements that fit the type description of a class, herein described as feature values. In this context, as presented in FIG. 3A, HOLIDAY, BIRTHDAY, and DAYTRIP are instances (feature values) of the class (feature) EVENT.

A class can have sub-classes, where the class is often also referred to as the super-class of the sub-class. A common relation between a super-class and a sub-class is that a super-class is a generalization and a sub-class is a specialization. In the example shown in FIG. 3A, the sub-classes PERSONAL EVENTS and WORK RELATED EVENTS are specializations of the super-class EVENT. Instances within the sub-class are also instances of the super-class. As presented above, HOLIDAY is an instance of the sub-class PERSONAL EVENTS, but also of the super-class EVENT. It should be noted that the sub-classes are not necessarily disjunctive of each other. The instance within one sub-class can also be an instance of another sub-class, as long as they share the same super-class.

In FIG. 3A, VINCE is an instance of the sub-class FRIEND and the sub-class COLLEAGUE, both sub-classes of the super-class PERSON. The classes EVENT, PERSON, and OBJECT typically have sub-classes that are defined through the relation of further specialization. LOCATION and TIME are other classes (features) that can be expressed having different levels of granularity which operates similar to different specialization in terms of the present system. For example, a photo album and/or a photo within the photo album can relate to THE NETHERLANDS, a relatively imprecise instance of the class LOCATION. The photo album may also relate to more precise ADDRESSES (feature values), including a particular STREET, CITY, and COUNTRY address, such as for example the KALVERSTRAAT, AMSTERDAM, and NETHERLANDS. The class LOCATION has the sub-classes CONTINENT, COUNTRY, CITY, and STREET, instances of varying granularity can be defined, by filling in one or more of the feature values (e.g., particular continents, countries, cities, and streets). These feature values are an aggregation of each other, for example a street is part of a city or town, which is part of a country, which is part of a continent.

The class TIME has similar characteristics to the class LOCATION. A time indication for photo albums and photos typically differs in granularity as well, from simple years to specific dates (being particular DAYS, MONTHS and YEARS). Useful sub-classes for the class TIME may be particular YEARS, MONTHS, and DAYS, which again are an aggregation of each other since a day is part of a month, which is part of a year.

As would be readily apparent, the terms utilized are not a required feature of the present system. The present system contemplates that collections of content items, groups of content items (e.g., albums), and/or individual content items within the collections and/or groups will have associated feature values that are particular instances of features. As would also be apparent, the exemplary correspondence of features and feature values shown in FIG. 3A is shown as an example, intended without limitation. Even within the example shown, variations are possible. For example, EVENT may be a feature with PERSONAL EVENTS and WORK RELATED EVENTS as corresponding feature values.

Some features and corresponding feature values share a relationship where the difference between a feature and corresponding feature values is a difference in granularity. For example, a feature may be TIME as shown in FIG. 3A that has corresponding feature values that may be particular YEARS, MONTHS, DAYS, etc. that are all at different granularities. Some features and corresponding feature values share a relationship where the feature and corresponding feature values have a same granularity. For example, a feature may be CITIES as shown in FIG. 3A that has corresponding feature values that may be LARGE CITIES, MEDIUM CITIES, AND SMALL CITIES, that all share the granularity of CITIES. However, the feature CITIES has corresponding feature values nonetheless.

As utilized herein, a feature is intended merely as a category (e.g., class) having corresponding elements within the category (e.g., instances) termed herein as feature values.

The present system contemplates utilizing techniques to ascertain the feature values that are associated with a collection of content items generally, groups of content items within the collection, and/or individual content items within the collection. For example, imaging techniques may be utilized to ascertain LOCATION feature values associated with a collection of photographs. U.S. patent application Ser. No. 10/295,668, filed Nov. 15, 2002, entitled “Content Retrieval Based On Semantic Association,” which is incorporated by reference herein, discloses methods for indexing multimedia content from different modalities. U.S. Pat. No. 6,243,713, filed Aug. 24, 1998, entitled “Multimedia Document Retrieval by Application of Multimedia Queries to a Unified Index of Multimedia Data For a Plurality of Multimedia Data Types,” by Nelson et al., which is incorporated by reference herein, discloses systems and methods for multimedia document retrieval by indexing compound documents, including multimedia components such as text, images, audio, or video components into a unified common index to facilitate document retrieval. Content items may also have feature values that are provided by a third party such as in the form of metadata associated with content items, such as Internet content. Feature values may also be provided by a user while consuming the content, such as viewing, sorting, etc. the content. In any event, any system of associating feature values with content items may be suitably utilized by the present system.

In operation, a user 50 wishes to locate a content item of particular interest from among a collection of content items. Computer system 100 stores within its database 55, one or more collections of content (see FIG. 1). Of course, in other embodiments, the collections of content may also be stored remotely and be accessed over a wireless or wired network, such as the Internet. This process begins with the user 50 logging on to the computer system 100 and being shown, via a user-interface, a visual representation of each collection of content stored in the database 55: e.g., (1) photographs 35, (2) music tracks 37 and (3) video tracks 39.

The user 50 may then be prompted by the computer system 100 to browse or filter (e.g., search) the collections of content 35, 37 and 39. In the instant example, the user 50 selects to filter the collections of content 35, 37 and 39 and just view a visual representation of the collection of photographs 35. In response to the user selection, the collection of photographs 35 is loaded from the database 55 into the memory 5 under control of the content locator module 10. In other embodiments, the user 50 may search other local and/or remote media sources other than database 55, including, for example, hard drives, CDs, floppy disks, servers and so on. It should also be noted that the media sources may or may not constitute property of the user 50. In other words, the media source may be a media source that is available to the general public for purposes of downloading and searching content. A search operation of a particular media source (e.g., CD) may return, for example, a collection of photographs and video tracks from a trip the user 50 took to Washington, D.C.

It is understood that the collection of photographs 35 may be voluminous and therefore it may be difficult for the user 50 to locate a particular photograph of interest. Thus, the present system overcomes this obstacle by performing a grouping operation in response to a filtering operation on the collection 35 to assist the user 50 in locating a photograph of interest. Upon loading the collection of photographs 35 into the memory 5, the user 50 has an option to perform a grouping operation on the collection of photographs 35 or an option to perform a filtering operation on the collection of photographs 35.

Assuming the user 50 has elected to perform a filtering operation, a filtering feature value is provided to the system to perform the filtering operation. In one embodiment, the computer system 100 may suggest possible feature values for use as a filtering feature value to filter the collection of photographs 35 to reduce the collection of photographs 35 to a more manageable size. For example, the system 100 may suggest the use of feature values corresponding to the features PERSON, or LOCATION, or OBJECT as candidate filtering parameters. The user 50 may utilize one of the feature values suggested by the system 100 or may otherwise choose a non-suggested feature value. In this or other embodiments, a suggestion of a feature and/or feature value may be nested, so that a selection of one by a user, results in a subsequent offer for selection of further filter features or filter feature values. An exemplary filter command may have the following form:

Command→FILTER on FRIEND

The user may instead, elect to filter on a more granular filter feature value, such as, for example:

Command→FILTER on VINCE

The filtering command 25 is transmitted to the content locator module 10 for execution. The result of the filtering operation comprises a reduced (filtered) collection of photographs 35 which may be stored in the memory 5 and may be utilized for further filtering/grouping operations.

Whenever the user 50 elects to perform a filtering operation, a grouping operation will be automatically performed by the system 100 in response to the filtering operation, to be described below in greater detail.

FIG. 2 is an illustration of a user interface 200 that may be shown to a user 50 as a result of the computer system 100 performing a user-selected filtering operation using HOLIDAY as a filtering feature value. The user interface shown has a filter selection area 210 and a grouping result area 220. A cursor 230 is shown in the filter selection area 210 and the filter feature value HOLIDAY is shown selected.

The computer system 100, in response to the user selected filtering operation and/or in response to the results of the filtering operation, illustratively selects a grouping feature LOCATION having corresponding grouping features values shown as HUNGARY, DISNEYLAND, and ROME. The grouping feature values are utilized for an automatic grouping operation. As shown, by automatically grouping on feature values of the feature LOCATION, the collection of content items (e.g., photographs, photo albums, etc.) resulting from a filtering operation are partitioned into sub-groups, such as HUNGARY 240, DISNEYLAND 250, AND ROME 260. As shown, grouping the filtered content serves to visually assist the user in locating the particular content of interest by spatially separating the content according to the grouping feature values of a grouping feature (e.g., LOCATION). As shown within the grouping result area 220, the visual depiction of the content items may convey a visual sense as to how large (absolutely or relative to other groupings) a particular grouping of content items is. For example, DISNEYLAND has relatively more content items in grouping 250 than either of ROME and HUNGARY as depicted respectively in groupings 260, 240. Further, ROME has relatively more content items in grouping 260 than HUNGARY as depicted in grouping 240. The content items within a grouping may be selected directly by, for example, positioning the cursor 230 on a content item within the grouping and performing a selection operation (e.g., click a corresponding mouse selection button). A person of ordinary skill in the art would readily appreciate that the groupings of content items may be depicted in numerous ways including depicting the individual content items within a grouping along a vertical portion of a corresponding indication. In this way, a number of content items within a grouping may be depicted as a width of the corresponding indication as opposed to a height of the corresponding indication. Clusters of individual content items may also be visually depicted as a grouping. In this embodiment, content items within a cluster would be visually depicted closer together than to content items in another cluster. Numerous other visual depictions may also be utilized.

In general, a user 50 searching for content will typically know some of the feature values associated with the collection of content to be searched and not know other feature values. For example, to locate a content item, such as a photo album of interest within a collection of photo albums, the user 50 may know certain feature values, such as, feature values of the features EVENT, LOCATION and PERSON, and not know other feature values, such as feature values of the feature DATE & TIME.

As briefly discussed above and in accordance with an embodiment, when the user elects to perform a filtering operation, the system thereafter performs an automatic grouping operation. Note, however, that the system 100 must determine which feature and corresponding feature values, to use for the grouping operation. An appropriate selection of a feature having corresponding feature values for use as a grouping feature may be to select the feature that is correlated with a filtering feature that corresponds to the user-selected filtering feature value for the previously performed filtering operation. For example, if the most recent filtering operation used the HOLIDAY feature value (having EVENT as a corresponding feature) as a filtering feature value, then the system 100 may determine that the LOCATION feature is correlated to the EVENT feature and thereby select LOCATION for use as grouping feature, where the corresponding feature values (e.g., particular COUNTRIES) are used to form the groups in the resulting view.

Based on the user-selected filtering feature value as described above, the present system groups the resulting subset of content items. The grouping feature by which the grouping is performed may be defined in a Feature Structure Model (FSM). Typically, the FSM is a table that describes rules of the format if {filter on feature value related to a user-selected filtering feature value} then (group by corresponding grouping feature}. For example, if {filter on an EVENT) then {group by LOCATION). The rules may also be of the format if {filter on a user-selected filtering feature value} then (group by corresponding grouping feature}; For example, if {filer on BIRTHDAY) then (group by PERSON).

FIG. 3B is an exemplary feature structure model 45 for use in the present system which maps exemplary correlated features. In particular, the left side of the feature structure model 45 lists features having corresponding feature values (e.g., see, FIG. 3A) of which the corresponding feature values may be utilized as filter feature values. These may be suggested to the user and/or may be feature values that the user 50 selects manually (e.g., without prompting by the system). Associated with each feature on the left hand side of the feature structure model 45, there is shown a corresponding feature on the right side for use as a grouping feature. FIG. 3B may readily incorporate all or a portion of FIG. 3A as would be readily appreciated by a person of ordinary skill in the art. Accordingly, the left side may also contain feature values as illustratively shown in FIG. 3A. The right side may also contain a specific granularity of a feature, for example grouping by COUNTRIES and/or CITIES (as a varying granularity of LOCATION), and/or for example grouping by DECADES, YEARS, and/or SEASONS (as a varying granularity of DATE & TIME). The features in each of the respective rows are associated for purposes of performing filtering/grouping on a collection of content. The feature structure model 45 of FIG. 3B is directed to a domain associated with a collection of photographs in accordance with the instant example. As previously mentioned, typical features associated with a collection of photographs may include, without limitation, EVENTS, LOCATIONS, PERSONS, OBJECTS, DATE & TIME, etc. For example and with reference to the third row of the table, it is shown that the PERSON feature is determined to be highly correlated (associated) with the DATE & TIME feature. As such, whenever, the user 50 elects to perform a filtering operation using, for example, VINCE as a filtering feature value, the system follows the filtering operation by performing a grouping operation using the feature DATE & TIME as a grouping feature. The system may group by different granularities YEARS, DECADES, etc., which may be determined intelligently by the system as a result of the content locator module 10 examining the results of the filtering operation and/or examining the results of different potential groupings.

While FIG. 3B shows a relationship between particular features on the left and right of the feature structure model 45, this is merely for illustrative purposes. In other embodiments, the system may dynamically determine associations between filtering and grouping features based on the feature values of the content. For example, a given filtering request may result in a particular subset of content that the system (e.g., content locator module 10) determines would be suitably grouped using a particular grouping feature having a corresponding feature that is different than the grouping feature present in the feature structure model 45. As shown in the feature structure model 45, should the user decide a filtering operation on an EVENT feature value, such as HOLIDAY, the feature structure model 45 shown in FIG. 3, would result in groupings based on the feature LOCATION having corresponding feature values that are utilized to create the individual groups. However, in some cases, this grouping may not result in assisting the user in viewing the results if, for example, all or many of the results, for example, where from one given location (e.g., had the same location feature value). In this case, the content locator module 10 may determine a different grouping feature, such as DATE & TIME that would be more suitably applied. In accordance with an embodiment, the content locator 10 may then use this more suitable grouping feature. In other embodiments, the system may have no fixed feature structure table and may determine the feature structure table dynamically based on the content feature values and/or may be based on user selection history. For example, every time the user filters on a person, the user may select to group by EVENT, so this behavior may then be stored as a relationship, for example a left and corresponding right side in the feature structure table.

Further, content items may have different types (e.g., different granularities) of location feature values. As an example, some photos and/or albums, may have only a city, such as ROME, others may have only a country, such as HUNGARY, and again others may have only a park name, such as DISNEYLAND, attached as metadata. When grouping on the feature LOCATION, the resulting groups may then be a mix of different types of locations. In the above example, the results may be the groups ROME, HUNGARY, and DISNEYLAND. This is in principle shown in FIG. 2, which illustratively shows the above three groups of different types of locations, a city, Rome 260, a country, Hungary 240, and a park, DISNEYLAND 250.

As would be readily apparent to a person of ordinary skill in the art, other given feature values not related to LOCATION feature values, for example, may also be determined dynamically by the system. For example, should the user decide a filtering operation on a given EVENT feature value, such as HOLIDAY, the feature structure model 45 may group a portion of the results by LOCATION based on given LOCATION feature values, such as particular COUNTRIES etc. However, when a result, or a portion thereof, from a filtering operation, has feature values not related to a LOCATION, such as feature values related to DATE & TIME, then groupings may be performed based on this additional feature (e.g., groupings based on feature values of the DATE & TIME feature) in place of the LOCATION feature.

In the same or alternate embodiments, when the groupings produced would be too small or large to assist the user, the system may dynamically determine more or less granular grouping feature values and/or different features to produce one or more of the groupings. For example, in a case wherein a group LOCATION feature granularity of CITIES (e.g., a feature value such as WASHINGTON D.C.) produces grouping results that are too small, the system may instead utilize a less granular grouping REGION feature (e.g., TIME ZONES). Similarly, in a case wherein a grouping LOCATION feature granularity of REGION (e.g., TIME ZONES) produces grouping results that are too large, the system may instead utilize a grouping CITIES feature granularity (e.g., with a feature value such as WASHINGTON D.C.).

A grouping feature determination may be made for an entire filter result or may be made based on particular grouping results from the feature structure table 45 (e.g., a particular grouping may provide results that are too small or large or a given feature may be completely absent from a portion of the results). For example, the content locator module may determine that a grouping result larger than ten (10) content items per group is too large and that a grouping result smaller than two (2) per group is too small, and thereby determine a suitable grouping feature granularity that meets this criterion (e.g., more or less granular feature values).

A grouping feature determination (granularity or otherwise) may also be made based on the number of groups resulting from potential grouping operations. Accordingly, in place of or together with determining a feature to group by in the feature structure model 45, the system (e.g., content locator module 10) may determine a suitable grouping feature by analyzing the grouping results when grouping on different features. The system may then select the feature (e.g., different granularity or just a different value) that, for example, yields a certain minimum/maximum number of groups (e.g., a minimum of 2 groups and a maximum of 10 groups), and/or groups with a certain minimum/maximum number of content items as discussed above. In other embodiments, this determination may be made based on other characteristics of the filtering/grouping results and/or may be made by the user and/or may be presented to the user for selection.

FIG. 4 illustrates a method 400 of operation of the current system, according to one embodiment. With further reference to FIG. 1, the content locator module 10 receives a command 25 from a user 50 at act 405. The command 25 may be either a user-selected filtering command or a user-selected grouping command to be applied to a collection of content (e.g. photographs 35). The locator module 10 reads the command at act 410. In decision act 415, the content locator module 10 determines whether the command type is a user-selected filtering command or a user-selected grouping command. In the case where the command is determined to be a user-selected filtering command, at act 420 a filtering operation is performed using a filtering feature value selected by the user 50. Next, at act 425, the content locator module 10 accesses the feature structure model 45 to determine a grouping feature for use in performing a grouping operation or determines one dynamically as discussed above. At act 430, the grouping operation is performed on the filtered collection of content 35 using the grouping feature determined at act 425 to produce groupings based on corresponding grouping feature values. The resulting filtered/grouped collection of content 35 is displayed to the user 50 at act 435. Returning to decision act 415, if it is determined that the command type read is a grouping command instead of a filtering command, the process continues at act 430 where a user-selected grouping operation is performed using a user-selected feature as a grouping feature. The grouped collection of content 35 is displayed to the user at act 435. In decision act 440, the user 50 determines whether he or she located the particular content of interest from the displayed collection of content 35. If the content is identified, the process terminates at act 445. Otherwise, a single cycle of operation is completed and the content locator 10 waits to receive a further command 25 from the user 50 at act 405 in a next cycle of operation. The process continues in the manner described above until the user either locates the particular content of interest at act 440 or terminates the process at act 445.

The embodiments of the present system described above are intended for purposes of illustration only, and should not be construed as limiting the appended claims to any particular embodiment or group of embodiments. Numerous alternative embodiments may be devised by those having ordinary skill in the art without departing from the spirit and scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

1. A method for assisting a user in locating particular content of interest from a collection of content including associated feature values that correspond to features, the method comprising the acts of:
a) determining, by the user, to filter the collection of content to yield a filtered collection of content using a filtering feature value,
b) selecting a grouping feature based on at least one of the filtering feature value and feature values associated with the filtered collection of content,
c) grouping the filtered collection of content using the selected grouping feature.

2. The method according to claim 1, wherein the grouping feature is determined as a function of the filtering feature value.

3. The method according to claim 1, wherein the grouping feature is determined as a function of the feature values associated with the filtered collection of content.

4. The method according to claim 1, further comprising repeating acts (a) through (c) in the case where the user is unable to locate the particular content of interest from act (c).

5. The method according to claim 1, further comprising the act of constructing a table, prior to the act (a), the table comprised of a plurality of rows, each of the rows including a filter feature and corresponding filtering feature values and at least one associated group feature having associated grouping feature values.

6. A system for assisting a user in locating particular content of interest from a collection of content including a plurality of associated feature values, the system comprising:
a content locator module configured to manage operations associated with filtering and/or grouping the collection of content, and
a feature structure model, operatively coupled to the content locator module, the feature structure model including a filter feature having associated filtering feature values and at least one associated group feature having associated grouping feature values.

7. The system of claim 6, comprising:
a means for accessing the collection of content;
a means for receiving a user-selected filtering feature value;
a means for performing a filtering operation on the collection of content using the user-selected filtering feature value to produce a filtered collection of content;
a means for selecting a grouping feature based on at least one of the user-selected filtering feature value and the plurality of feature values of the filtered collection of content; and
a means for performing a grouping operation on the filtered collection of content using the grouping feature.

8. The system according to claim 6, further comprising means for storing the collection of content.

9. The system according to claim 6, further comprising display means for displaying a filtered/grouped collection of content to the user.

10. A computer-readable medium encoded with processing instructions for implementing a method for assisting a user in locating particular content of interest from a collection of content including associated feature values that correspond to features, the method including the acts of:
determining, by the user, to filter the collection of content to yield a filtered collection of content using a filtering feature value from among the feature values, wherein the filtering feature value is user-selected;
selecting a grouping feature based on at least one of the user-selected filtering feature value and a feature of the filtered collection of content; and
grouping the filtered collection of content using the selected grouping feature.

11. The computer-readable medium of claim 10, wherein the act of determining, by the user, to filter the collection of content comprises the act of presenting to the user at least one of the plurality of feature values for user selection as the filtering feature value.

12. The computer-readable medium of claim 10, wherein the act of selecting the grouping feature comprises the act of analyzing the feature values of the filtered collection of content to determine grouping feature granularity.

13. The computer-readable medium of claim 10, wherein the act of selecting the grouping feature comprises the act of analyzing results of potential groupings using feature values of the filtered collection.
